(19) United States
(12) Patent Application Publication
(10) Pub. No.: US 2011/0272446 A1
(43) Pub. Date: Nov. 10, 2011

(54) BICYCLE BASKET

(75) Inventor: Ming-Yung Chen, CHANGHUA HSIEN (TW)

(73) Assignee: BRANC CO., LTD., CHANGHUA HSIEN (TW)

(21) Appl. No.: 12/776,423

(22) Filed: May 9, 2010

(51) Int. Cl. B62J 9/00

(52) U.S. Cl. 224/419

(57) ABSTRACT

A bicycle basket includes at least two support tubes, an upper enclosing frame, a plurality of intermediate frames and a lower enclosing frame, all of which are welded together, and a bottom panel locked onto the two support tubes. The at least two support tubes are parallel hollow tubes. Each support tube is U-shaped and comprises a bottom section at a middle portion, at least two bent sections extending from the bottom section, and two vertical sections. The upper enclosing frame is welded onto the at least two support tubes at an outer side of the end of the vertical section. The plurality of intermediate frames are regularly welded on an outer edge of the vertical section to form a containment space with the upper enclosing frame, the lower enclosing frame being welded on an outer edge of the bent section of the at least two support tubes.

### BACKGROUND OF THE INVENTION

1. Field of the Invention

The present invention relates to a bicycle basket, and more particularly to a bicycle basket providing a strong, light-weight structure.

2. Description of the Related Art

Currently, typical bicycle baskets enable users to transport items more conveniently, and their various designs can provide different looks for the bicycle. However, traditional bicycle baskets are composed of an upper and lower enclosing frame made of solid metal wire and a woven metal sidewall that connects the upper and lower enclosing frames together, which forms a containment space. A securing plate having locking apertures is welded onto one side of the basket and is used for attachment to the bicycle through the locking aperture.

Consequently, there are several drawbacks present in the traditional basket: 1. Since the basket is composed of upper and lower enclosing frames connected by the woven metal sidewall, external forces will be evenly distributed on the entire basket structure, but the woven metal sidewall has a stress tolerance that is lower than that of the upper and lower enclosing frames, and so is more easily deformed or damaged by heavy items or accidents. 2. The basket made of solid metal material has higher material costs and a heavier weight.

Therefore, it is desirable to provide a bicycle basket to mitigate and/or obviate the aforementioned problems.

### SUMMARY OF THE INVENTION

An objective of the present invention is to provide a bicycle basket.

In order to achieve the above-mentioned objective, a bicycle basket of the present invention has at least two support tubes made of aluminum, an upper enclosing frame, a plurality of intermediate frames and a lower enclosing frame, all of which are welded together, and a bottom panel locked onto the two support tubes. The at least two support tubes are parallel hollow tubes; each support tube is U-shaped and comprises a bottom section at a middle portion, at least two bent sections extending from the bottom section, and two vertical sections. The support tube further comprises a plug inserted into an end opening of the vertical section. The upper enclosing frame is welded onto the at least two support tubes at an outer side of the end of the vertical section such that the upper enclosing frame and the vertical section form a top support for the basket. Both sides of the upper enclosing frame respectively and symmetrically have an ear extending upwardly, and a handle is pivoted onto each of the ears via a pin. A plurality of intermediate frames are regularly welded on an outer edge of the vertical section to form a containment space with the upper enclosing frame. The lower enclosing frame is welded on an outer edge of the bent section of the at least two support tubes, such that the lower enclosing frame with the bottom section forms a bottom support for the basket. The bottom panel is placed in the basket and screwed onto the bottom section, and an assembly member is welded onto the at least two support tubes between the two vertical sections and used for attachment to a bicycle.

Accordingly, the bicycle basket of the present invention provides the following benefits:

1. When the items are placed on the bottom board, the weight of the items presses onto the bottom section of the support tube through the bottom board; the bottom section further extends as the vertical section, the upper and lower enclosing frame tighten the outsides of the at least two support tubes, and the upper and lower enclosing frame and the support tube are welded together, such that external stress is concentrated on the at least two support tubes to improve structural strength. Therefore, the basket is free from suffering deformation or damage from heavy items.

2. The upper and lower enclosing frame and the intermediate frames are all welded onto the at least two support tubes, so that the support tube and the upper and lower enclosing frames form a main structure that provides structural strength and a reduced diameter size for the intermediate frames to provide a lighter weight.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an embodiment of the present invention.

FIG. 2 is an exploded view of an embodiment of the present invention.

FIG. 3 is a front view of an embodiment of the present invention.

FIG. 4 is a local detailed and cross-sectional view of an embodiment of the present invention.

FIG. 5 is schematic drawing of a plug according to an embodiment of the present invention.

### DETAILED DESCRIPTION OF THE PREFERRED EMBODIMENT

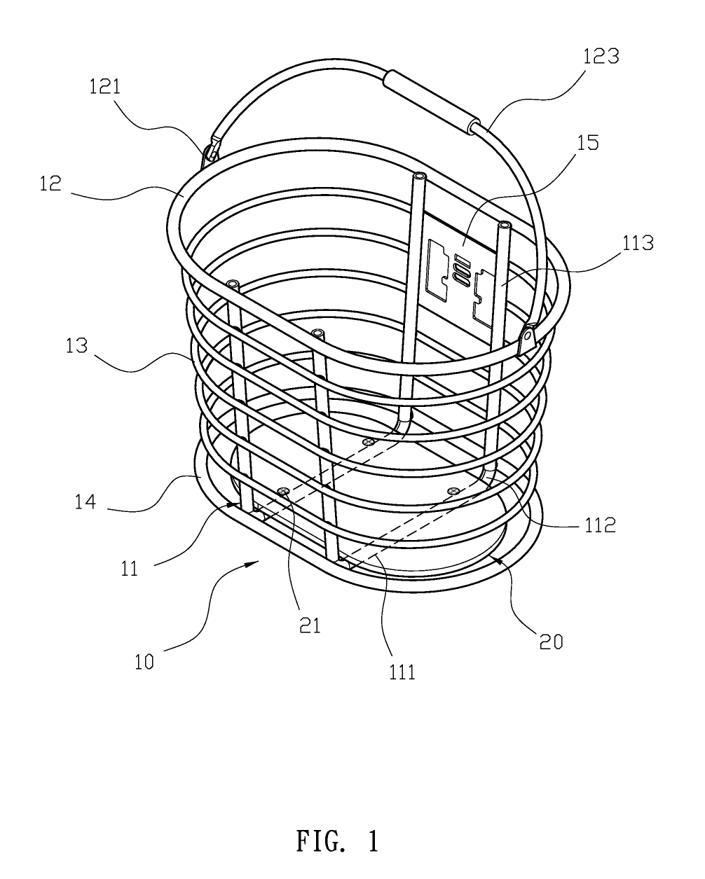

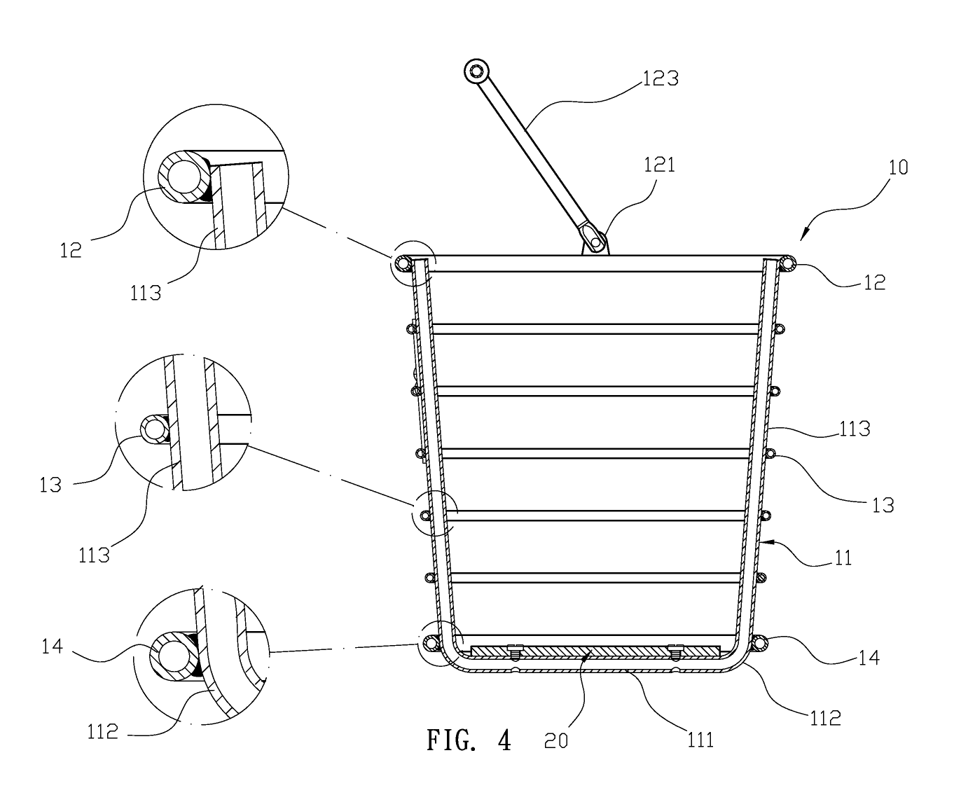

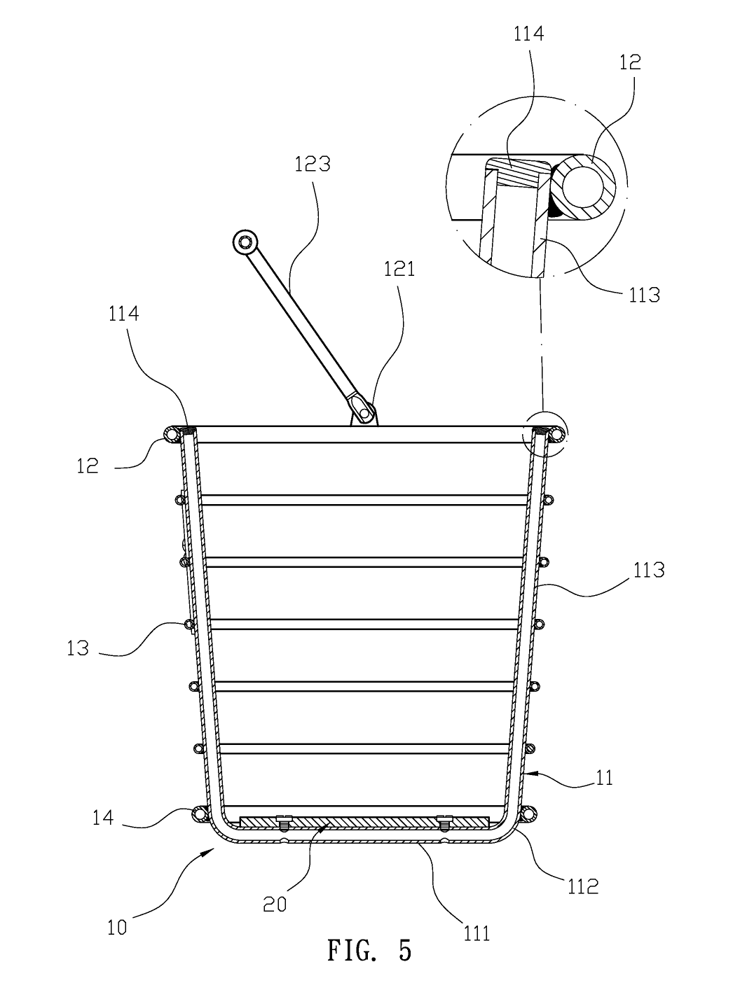

Please refer to FIG. 1 to FIG. 4. A bicycle basket 10 comprises at least two support tubes 11 made of aluminum, an upper enclosing frame 12, a plurality of intermediate frames 13 and a lower enclosing frame 14, all of which are welded together, and a bottom panel 20 that is locked onto the two support tubes 11. The at least two support tubes 11 are parallel hollow tubes; each support tube 11 is U-shaped and comprises a bottom section 111 at a middle portion, at least two bent sections 112 extending from the bottom section 111, and two vertical sections 113. The support tube 11 further comprises a plug 114 inserted into each end opening of the vertical section 113, as shown in FIG. 5. The upper enclosing frame 12 is welded onto the at least two support tubes 11 at an outer side of the end of the vertical section 113 such that the upper enclosing frame 12 and the vertical section 113 form a top support for the basket 10. Both sides of the upper enclosing frame 12 respectively and symmetrically have an ear 121 extending upwardly, and a handle 123 is pivoted onto each of the ears via a pin 122. The plurality of intermediate frames 13 are welded regularly spaced on an outer edge of the vertical section 113 to form a containment space with the upper enclosing frame 12. The lower enclosing frame 14 is welded on an outer edge of the bent section 112 of the at least two support tubes 11, such that the lower enclosing frame 14 with the bottom section 111 forms a bottom support for the basket 10. The bottom panel 20 is placed in the basket 10 and screwed onto the bottom section 111 via screws 21, and an assembly member 15 is welded onto the at least two support tubes 11 between the two vertical sections 113 and used for attachment to a bicycle.

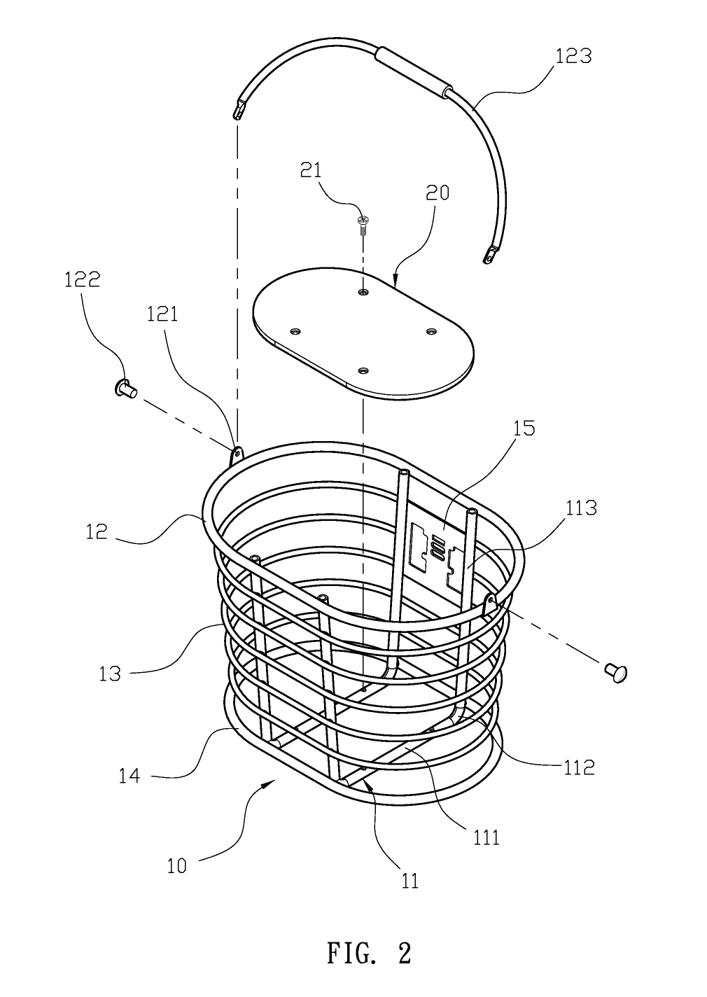

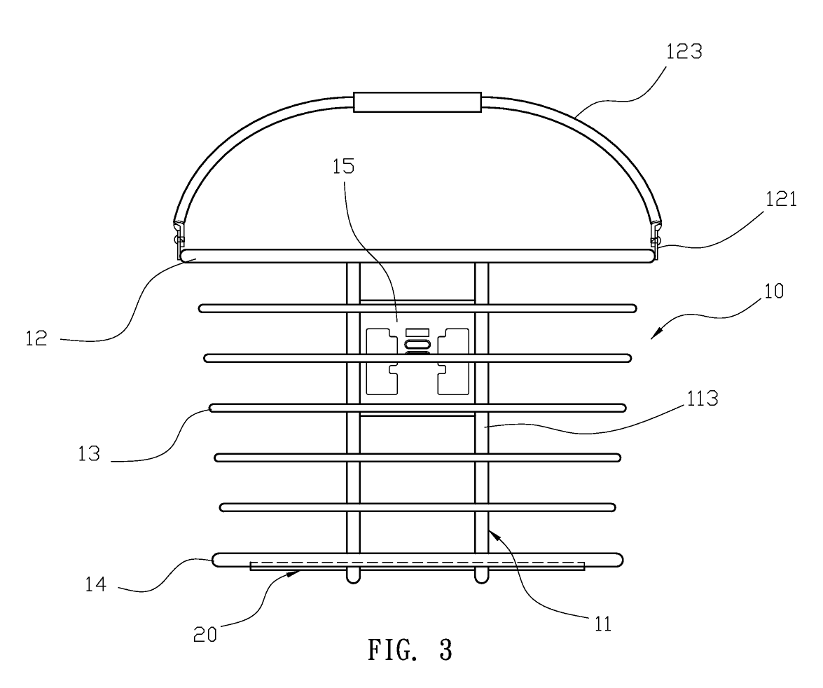

Please refer again to FIG. 2 and FIG. 3. In usage, the basket 10 utilizes the assembly member 15 for attachment to a front side of the handlebars or a side of the bicycle, and the user can place items in the containment space of basket 10. The bottom panel 20 screwed onto the bottom section 111 provides a stable bottom for the placement of items and the intermediate frame 13 provides a sidewall to contain the items within the bicycle basket 10. In addition, when the basket 10 is dissembled from the bicycle, the user can use one hand to grip the handle 123 to carry items with the basket 10. Accordingly, the bicycle basket of the present invention provides the following benefits: 1. When the items are placed on the bottom board 20, the weight of the items presses onto the bottom section 111 of the support tube 11 through the bottom board 20, the bottom section 111 further extends as the vertical section 113, the upper and lower enclosing frames 12, 14 tighten outsides of the at least two support tubes 11, and the upper and lower enclosing frames 12, 14 and the support tube 11 are welded together, such that external stress is concentrated on the at least two support tubes to improve structural strength. Therefore, the basket 10 can be free from deformation or damage by heavy items. 2. The upper and lower enclosing frame 12, 14 and the intermediate frame 13 are all welded onto the at least two support tubes 11, so the support tube 11 and the upper and lower enclosing frames 12, 14 form a main structure that provides increased structural strength and provides for reduction in the size of the diameter of the intermediate frame for a lighter weight.

Although the present invention has been explained in relation to its preferred embodiment, it is to be understood that many other possible modifications and variations can be made without departing from the spirit and scope of the invention as hereinafter claimed.

What is claimed is:

1. A bicycle basket comprising at least two support tubes, an upper enclosing frame, a plurality of intermediate frames and a lower enclosing frame, all of which are welded together, and a bottom panel locked onto the two support tubes; the bicycle basket characterized in that:
the at least two support tubes are parallel hollow tubes, each support tube being U-shaped and comprising a bottom section at a middle portion, at least two bent sections extending from the bottom section, and two vertical sections; the upper enclosing frame being welded onto the at least two support tubes at an outer side of the end of the vertical section such that the upper enclosing frame and the vertical section form a top support for the basket; the plurality of intermediate frames being welded on an outer edge of the vertical section to form a containment space with the upper enclosing frame; the lower enclosing frame being welded on an outer edge of the bent section of the at least two support tubes, such that the lower enclosing frame with the bottom section forms a bottom support for the basket, and the bottom panel is placed in the basket and screwed onto the bottom section;
wherein the upper and lower enclosing frames tighten outsides of the at least two support tubes such that external stress is concentrated on the at least two support tubes to improve structural strength and reduce the diameter size of the intermediate frame for a lighter weight.

2. The bicycle basket as claimed in claim 1, wherein the basket is made of aluminum, and the upper and lower enclosing frames and intermediate frames are all hollow tubes.

3. The bicycle basket as claimed in claim 1, wherein both sides of the upper enclosing frame respectively and symmetrically have an ear extending upwardly, and a handle is pivoted onto each of the ears via a pin.

4. The bicycle basket as claimed in claim 1, wherein an assembly member is welded onto the at least two support tubes between the two vertical sections and used for attachment to a bicycle.

5. The bicycle basket as claimed in claim 1, wherein the support tube further comprises a plug inserted into an end opening of the vertical section.
